(19) United States
(12) Patent Application Publication
(10) Pub. No.: US 2026/0119208 A1
(43) Pub. Date: Apr. 30, 2026

(54) DISPLAY CONTROL METHOD, USER TERMINAL DEVICE, AND STORAGE MEDIUM

(71) Applicant: Lenovo (Beijing) Limited, Beijing (CN)

(72) Inventors: Ying SONG, Beijing (CN); Ke WANG, Beijing (CN)

(21) Appl. No.: 19/370,200

(22) Filed: Oct. 27, 2025

(30) Foreign Application Priority Data
Oct. 31, 2024 (CN) 202411552131.0

(51) Int. Cl. G06F 9/451; G06F 3/04845

(52) U.S. Cl. CPC G06F 9/451; G06F 3/04845

(57) ABSTRACT

A display control method includes: displaying an initial interaction interface, the initial interaction interface including at least a first interaction area; and controlling the first interaction area to output a task interaction interface corresponding to an execution state of a target processing task, so as to present different visual effects at different task stages. The target processing task is obtained by a user terminal device based on an input operation applied to the first interaction area; and before the target processing task is obtained, a visual effect presented by the first interaction area is different from a visual effect presented by the first interaction area after the target processing task is obtained.

### CROSS-REFERENCES TO RELATED APPLICATIONS

The present disclosure claims priority to Chinese Patent Application No. 202411552131.0, filed on October 31, 2024, the content of which is incorporated herein by reference in its entirety.

### TECHNICAL FIELD

The present disclosure relates to the field of computer technology, and more specifically, relates to a display control method and a user terminal device.

### BACKGROUND

In system programs and application programs of computer devices, user interface design typically relies on static elements and simple transition effects to attract the user’s attention. However, static elements may hardly attract the user’s attention, resulting in a monotonous and dull user interface; whereas simple transition effects may provide a user experience that is insufficiently smooth.

Accordingly, how to design display effects of a user interface so as to improve the user’s experience has become an urgent issue.

### SUMMARY

One aspect of the present disclosure provides a display control method. The display control method includes: displaying an initial interaction interface, the initial interaction interface including at least a first interaction area; and controlling the first interaction area to output a task interaction interface corresponding to an execution state of a target processing task, so as to present different visual effects at different task stages. The target processing task is obtained by a user terminal device based on an input operation applied to the first interaction area; and before the target processing task is obtained, a visual effect presented by the first interaction area is different from a visual effect presented by the first interaction area after the target processing task is obtained.

Another aspect of the present disclosure provides a user terminal device. The user terminal device includes at least one processor and at least one processing model operable on the at least one processor, the processing model being invocable by a target application to execute at least one of following operations by the at least one processor: displaying an initial interaction interface, the initial interaction interface including at least a first interaction area; and controlling the first interaction area to output a task interaction interface corresponding to an execution state of a target processing task so as to present different visual effects at different stages of the target processing task. The target processing task is obtained by the user terminal device based on an input operation applied to the first interaction area; and before the target processing task is obtained, a visual effect presented by the first interaction area is different from a visual effect presented after the target processing task is obtained.

Another aspect of the present disclosure provides a non-transitory computer readable storage medium containing at least one processing model operable on at least one processor, the processing model being invocable by a target application to execute at least one of following operations by the at least one processor: displaying an initial interaction interface, the initial interaction interface including at least a first interaction area; and controlling the first interaction area to output a task interaction interface corresponding to an execution state of a target processing task so as to present different visual effects at different stages of the target processing task. The target processing task is obtained by the user terminal device based on an input operation applied to the first interaction area; and before the target processing task is obtained, a visual effect presented by the first interaction area is different from a visual effect presented after the target processing task is obtained.

### BRIEF DESCRIPTION OF THE DRAWINGS

The drawings are incorporated into and constitute a part of the specification. The drawings illustrate embodiments consistent with the present disclosure and, together with the description, are used to explain technical solutions of the present disclosure.

FIG. 1 illustrates an implementation flowchart of a display control method in accordance with some embodiments of the present disclosure.

FIG. 2 illustrates an application download interface in an interaction interface of the display control method in accordance with some embodiments of the present disclosure.

FIG. 3 illustrates an account login interface in an interaction interface of the display control method in accordance with some embodiments of the present disclosure.

FIG. 4 illustrates a login interface in an interaction interface of the display control method in accordance with some embodiments of the present disclosure.

FIG. 5 illustrates an initial interaction interface of an AI computing share application of the display control method in accordance with some embodiments of the present disclosure.

FIG. 6 illustrates a task processing interface of an AI computing share application of the display control method in accordance with some embodiments of the present disclosure.

FIG. 7 illustrates a task processing interface of an AI computing share application of the display control method in accordance with some embodiments of the present disclosure.

FIG. 8 illustrates an interaction interface of an AI computing share application of the display control method in accordance with some embodiments of the present disclosure.

FIG. 9 illustrates an interaction interface of an AI computing share application of the display control method in accordance with some embodiments of the present disclosure.

FIG. 10 illustrates a device information interface of an AI computing share application of the display control method in accordance with some embodiments of the present disclosure.

FIG. 11 illustrates an initial interaction interface of an AI computing share application of the display control method in accordance with some embodiments of the present disclosure.

FIG. 12 illustrates a schematic structure diagram of a display control apparatus in accordance with some embodiments of the present disclosure.

FIG. 13 illustrates a schematic diagram of the hardware entity of a user terminal device in accordance with some embodiments of the present disclosure.

### DETAILED DESCRIPTION

To make the objectives, technical solutions, and advantages of the present disclosure clearer, the technical solutions of the present disclosure are further described in detail below in conjunction with the drawings and embodiments. The embodiments described are not to be construed as limiting the present disclosure, and all other embodiments that may be obtained by those of ordinary skill in the art without creative labor fall within the scope of protection of the present disclosure.

In the following description, references to “some embodiments” describe a subset of all possible embodiments; it is to be understood that “some embodiments” may be the same or different subsets of all possible embodiments, and, where there is no conflict, they may be combined with one another.

The terms “first/second/third” are used merely to distinguish similar objects and do not represent a particular ordering of the objects. It is to be understood that, where permitted, “first/second/third” may be interchanged in specific order or sequence so that the embodiments of the present disclosure described herein may be implemented in orders other than those illustrated or described herein.

Unless otherwise defined, all technical and scientific terms used herein have the same meaning as commonly understood by those skilled in the art to which the present disclosure pertains. The terms used herein are for the purpose of describing the present disclosure and are not intended to limit the present disclosure.

The present disclosure provides a display control method that may be executed by a processor of a computer device. Here, the computer device may refer to devices having display control capabilities, which may include a server, a laptop computer, a tablet computer, a desktop computer, a smart television, a set-top box, or a mobile device (for example, a mobile phone, a portable video player, a personal digital assistant, a dedicated messaging device, or a portable gaming device).

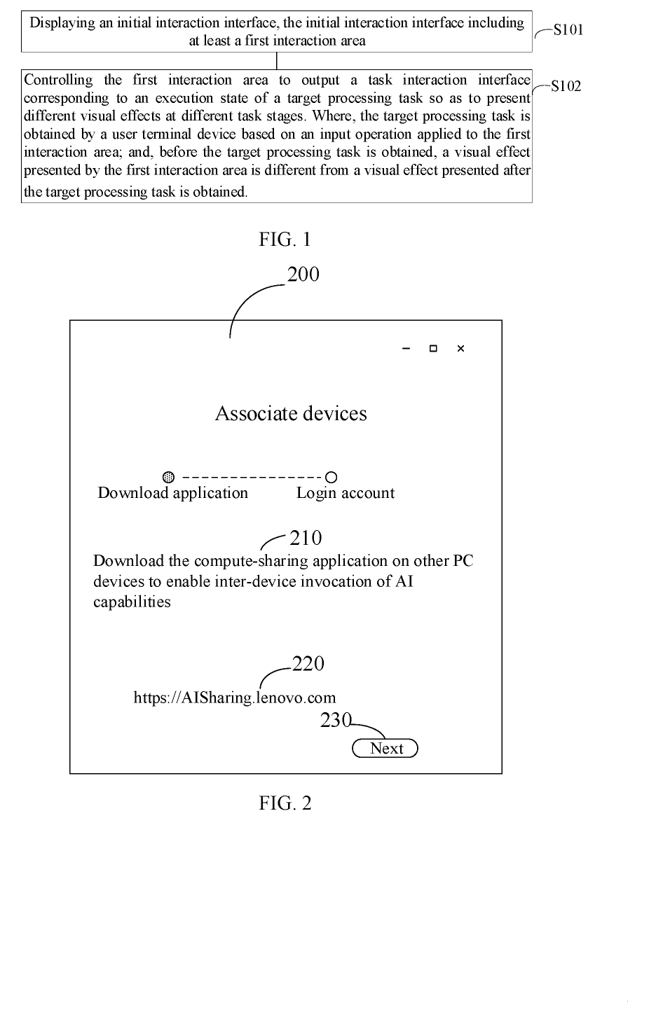

FIG. 1 illustrates an implementation flowchart of a display control method in accordance with some embodiments of the present disclosure. As shown in FIG. 1, the method includes steps S101 to S102.

Step S101: displaying an initial interaction interface, the initial interaction interface including at least a first interaction area.

Where, the initial interaction interface refers to an initial interface corresponding to a target application that executes the display control method provided by the present disclosure.

In some embodiments of the present disclosure, the initial interaction interface includes a main interface corresponding to the target application or an initial login interface.

In some embodiments of the present disclosure, after logging into the target application or launching the target application, the initial interaction interface is displayed.

In some embodiments of the present disclosure, the target application that executes the display control method provided by the present disclosure is an Artificial Intelligence Computing Share (AI computing share) application.

The first interaction area refers to a main display region in the initial interaction interface.

In some embodiments of the present disclosure, the first interaction area is a task input region in the initial interaction interface, and provides at least one control for receiving user input information. For example, the first interaction area includes at least one of a text input box, a voice input control, a gesture input control, a video input control, and/or other controls that may receive a user task.

In some embodiments of the present disclosure, the first interaction area is a region in the initial interaction interface for presenting a task processing procedure and a task processing result.

Step S102: controlling the first interaction area to output a task interaction interface corresponding to an execution state of a target processing task so as to present different visual effects at different task stages.

The target processing task is obtained by a user terminal device based on an input operation applied to the first interaction area; and, before the target processing task is obtained, a visual effect presented by the first interaction area is different from a visual effect presented after the target processing task is obtained.

Where, the target processing task refers to a task processed by the target application that executes the display control method provided by the present disclosure, or a task processed by invoking computing resources of other devices through the target application.

In some embodiments of the present disclosure, the target task is determined based on an input operation applied by a user to the first interaction area.

In some embodiments of the present disclosure, the target task is determined based on text data input by the user through a text input box of the first interaction area.

In some embodiments of the present disclosure, the target task is determined based on image data uploaded by the user through an image upload control in the first interaction area.

In some embodiments of the present disclosure, the target task is determined based on voice data input by the user through a voice input control in the first interaction area.

In some embodiments of the present disclosure, the target processing task may be an image generation task, a text generation task, a video generation task, or an image processing task.

The execution state of the target processing task refers to execution progress information for the target processing task.

In some embodiments of the present disclosure, the execution state of the target processing task may include a state where the user terminal device establishes a communication connection with another processing device that collaboratively processes the target processing task, a state where the user terminal device shares task data with another processing device, a state where a system is processing the target task, and a state where the target processing task has been processed and a processing result is output, and the like.

In some embodiments of the present disclosure, the execution state of the target processing task may further include task state changes caused by adjustments made by the user to an association relationship between the user terminal device and another device, or by changes in an operating state of another device. For example, after the target processing task is determined, the user may add another device as a device that collaboratively processes the target processing task, thereby causing a change in the execution state. For another example, during execution of the target processing task, the execution state may change because a device that collaboratively processes the target processing task goes offline.

In some embodiments of the present disclosure, the execution state of the target processing task may further include execution progress information of the target processing task. For example, the execution state may include an execution percentage of the target processing task, an execution completion state, and the like.

The task interaction interface refers to an interface that is obtained, after the target processing task is acquired, by updating the initial interaction interface and displaying the update as output.

A task interaction interface corresponding to the task execution state is displayed and output in the first interaction area, so that a user may intuitively obtain task execution state information through visual effects of the task interaction interface.

Task stages correspond to execution states, that is, each execution state corresponds to one task stage.

In some embodiments of the present disclosure, task stages include a task initiation stage, a task distribution stage, and a task collaborative processing stage. Where, the task initiation stage corresponds to an input state of the target processing task; the task distribution stage corresponds to a state where the user terminal device establishes a communication connection with another processing device that collaboratively processes the target processing task and a state where the user terminal device shares task data with another processing device; and a task completion stage corresponds to execution states such as a state where the target task is collaboratively processed and a state where the target processing task has been processed and a processing result is output.

At different task stages, the task interaction interface displays and outputs different visual effects.

In some embodiments of the present disclosure, at the task initiation stage, the task interaction interface displays optical paths and digital streams flowing into the text input box or optical paths and digital streams flowing out of the text input box.

In some embodiments of the present disclosure, at the task distribution stage, the task interaction interface displays and outputs optical paths and digital streams flowing upward from the text input box; or, when displaying and outputting a generated image result, a downward particle reconstruction effect is added below a partially displayed portion of the image until the image is completely displayed.

In some embodiments of the present disclosure, at the task collaborative processing stage, the task interaction interface displays and outputs visual effects of task execution results. For example, a highlighted background effect is added to an image that is completely generated and displayed.

Before the target processing task is obtained, a visual effect presented by the first interaction area is different from a visual effect presented after the target processing task is obtained, so as to intuitively indicate to the user whether the current state is a task execution state. For example, before the target processing task is obtained, optical paths and digital streams flowing toward the text input box and rebounding upward from the text input box are displayed in the first interaction area, similar to a splash effect after a water droplet falls onto the text input box, to express that there is currently no text input; and after the target processing task is obtained, effects displayed on the task interaction interface at the task initiation stage, the task distribution stage, and the task collaborative processing stage as described above are displayed.

In view of the foregoing, in the display control method provided by the present disclosure, a first interaction area in an initial interaction interface is controlled to output a task interaction interface corresponding to an execution state of a target processing task, so as to present different visual effects at different task stages; the target processing task is obtained by a user terminal device based on an input operation applied to the first interaction area; and, before the target processing task is obtained, a visual effect presented by the first interaction area is different from a visual effect presented after the target processing task is obtained. Thus, by displaying and outputting different visual effects in the first interaction area or in the task interaction interface corresponding to the first interaction area before and after the target processing task is obtained and at different task stages corresponding to the target processing task, a user may intuitively perceive whether there is a task being executed and a current task stage of the task, thereby better attracting the user’s attention and improving an amusement of a user interaction process.

In some embodiments of the present disclosure, the display control method provided further includes Step S103.

Step S103: controlling a second interaction area of the initial interaction interface to output a device interaction interface corresponding to the execution state, so as to present a processing procedure of the target processing task.

The device interaction interface includes an avatar of the user terminal device and at least one processing device in a target device group, where the user terminal device belongs to or does not belong to the target device group.

Display parameters of the avatar in the device interaction interface corresponding to different execution states are different.

Where, the second interaction area is a region in the initial interaction interface for displaying device information of at least one device associated with the user terminal device.

In some embodiments of the present disclosure, the second interaction area is adjacent to the first interaction area. For example, the second interaction area is arranged on a left side of the first interaction area to satisfy ergonomic design requirements.

A device interaction interface is displayed and output in the second interaction area so as to visually present device state change information in the second interaction area and/or information indicating changes in a communication state or an association relationship between different devices. Then, through the device state change information and/or the information indicating changes in the inter-device communication state or association relationship, a processing procedure of the target processing task, that is, a task stage of the target processing task, is characterized.

In the second interaction area, devices displayed include the user terminal device and at least one processing device in a target device group.

Where, the user terminal device is a device currently operated by a user, that is, a device that displays the above initial interaction interface.

A processing device in the target device group refers to a device having AI processing capability and associated with the user terminal device.

In some embodiments of the present disclosure, processing devices may include devices having AI processing capability such as a server on a public network, a server on a local area network, a personal computer (PC), a tablet computer, a personal digital assistant, or a mobile device.

In some embodiments of the present disclosure, AI processing capability of a processing device corresponds to a task initiated by the user terminal device so as to assist in executing the task initiated by the user terminal device.

The target device group is a device cluster formed by a plurality of processing devices, and processing devices in the target device group may be managed by the user terminal device or by a first device in the target device group.

In some embodiments of the present disclosure, the target device group may be a group formed by devices having AI processing capability in a home environment or an office environment where the user terminal device is located. For example, in a local area network established in an office environment, a target device group is established using servers and PCs in the local area network.

In some embodiments of the present disclosure, the target device group may further be a group formed by cloud processing devices under a specific network environment. For example, a target device group is established by cloud servers provided by a network service provider.

Where, the user terminal device may belong to or may not belong to the target device group.

For example, when the user terminal device is an AI device having AI processing capability, the user terminal device may belong to the target device group; or when the user terminal device is an ordinary device without AI processing capability, the user terminal device may not belong to the target device group.

In some embodiments of the present disclosure, all processing devices in the target device group are displayed in a device interaction interface of the user terminal device.

In some embodiments of the present disclosure, a portion of the processing devices in the target device group is displayed in the device interaction interface of the user terminal device.

Where, when at least one processing device in the target device group is displayed in the device interaction interface, the at least one processing device displayed may be a device that receives the target processing task and/or a device that provides computing power to execute the target processing task, and may further be a device in the target device group that is capable of executing the target processing task but is currently in an offline state, a busy state, or not selected to process the target processing task.

An avatar of at least one processing device refers to a virtual representation used to identify the corresponding processing device.

In some embodiments of the present disclosure, an avatar of at least one processing device may be a virtual planet avatar. Thus, different planet avatars may be used to represent different processing devices.

In some embodiments of the present disclosure, the device interaction interface also includes a dynamic background. For example, when the avatar of at least one processing device is a virtual planet avatar, a nebula in a cosmic system where the planet is located may be used as a dynamic background for the avatar.

Thus, the second interaction area is controlled to output a corresponding device interaction interface so as to present a processing procedure of the target processing task, that is, a task stage of the target processing task is characterized by adjusting a device display state of the user terminal device and at least one processing device in the device interaction interface and/or an association relationship between devices, thereby reflecting an entire task processing procedure.

Under different execution states, that is, at different task stages, display parameters of avatars in the device interaction interface are different, that is, at different task stages, display parameters of avatars of the user terminal device and processing devices that collaboratively process the target processing task are different from one another.

In some embodiments of the present disclosure, display parameters may include a display size of an avatar. For example, at a task initiation stage, display sizes of avatars of the user terminal device and other processing devices are the same; at a task distribution stage, avatars of the user terminal device and processing devices that collaboratively process the target processing task are enlarged; and, at a task completion stage, avatars of the user terminal device and processing devices that collaboratively process the target processing task are restored.

In some embodiments of the present disclosure, display parameters may include a positional layout of an avatar. For example, at the task initiation stage, avatars of the user terminal device and other processing devices are arranged according to a preset arrangement order; and, at the task distribution stage, avatars of the user terminal device and processing devices that collaboratively process the target processing task are adjusted to be displayed at a top of the device interaction interface.

In some embodiments of the present disclosure, display parameters may include a display state of an avatar. For example, at different task processing stages, avatars of the user terminal device and other processing devices switch between dynamic display and static display.

In some embodiments of the present disclosure, display parameters may include a display theme of an avatar. For example, at different task processing stages, display themes of avatars of the user terminal device and processing devices that collaboratively process the target processing task are switched.

In the above embodiments, based on an execution state of the target processing task, a device interaction interface is displayed in the second interaction area. Thus, by adjusting display parameters of avatars of the user terminal device and at least one processing device in the device interaction interface, a processing procedure of the target processing task is presented. In this way, interface components in the device interaction interface may dynamically present the task processing procedure, attract a user’s attention, and improve interactive interest.

In some embodiments of the present disclosure, controlling the first interaction area to output a task interaction interface corresponding to the execution state of the target processing task, that is, Step S102 above, may be implemented as the following Steps S1021 to S1022.

Step S1021: in response to obtaining the target processing task, monitoring the execution state of the target processing task.

Where, monitoring the execution state of the target processing task may include monitoring an input state of the target processing task, an execution progress of the target processing task, whether the execution of the target processing task is completed, and the like.

In some embodiments of the present disclosure, in response to obtaining the target processing task, a communication connection state between the user terminal device and processing devices in a target device group is monitored. For example, whether the user terminal device is connected to at least one processing device having corresponding AI processing capability is monitored; a network speed of a communication connection between the user terminal device and at least one processing device is monitored; and the like.

In some embodiments of the present disclosure, in response to obtaining the target processing task, a task data transmission state between the user terminal device and at least one processing device determined to assist in task processing is monitored. For example, a transmission speed at which the user terminal device transmits task data to at least one processing device is monitored; a transmission speed at which at least one processing device feeds back a task processing result to the user terminal device is monitored; and the like.

In some embodiments of the present disclosure, processing progress information of the target processing task of the user terminal device and/or at least one processing device, and hardware computing resource information in at least one processing device, are monitored.

In some embodiments of the present disclosure, adjustments made by a user to an association relationship between the user terminal device and another processing device, or information on changes in an operating state of another processing device, and the like, are monitored.

Step S1022: updating first display information of a display area in the first interaction area based on the execution state so as to present different task interaction interfaces, where the first display information includes display content and/or a display parameter.

Where, the display area refers to an area in the first interaction area other than an area where controls for receiving user input operations are located. For example, the display area refers to an area other than areas where a text input box, a voice input control, a gesture input control, a video input control, and the like, are located in the first interaction area.

Updating the first display information of the display area means updating display content and/or a display parameter of the first display information in the display area.

In some embodiments of the present disclosure, a display parameter may include a dynamic refresh rate corresponding to the display area, a playback rate of display content, color, transparency, and the like. For example, when the first display information is optical paths and digital streams flowing into a text input box, updating the first display information may include updating a flow speed of the optical paths and the digital streams; when the first display information is a particle reconstruction effect below an image being generated, a particle flow speed may be updated according to an image generation speed, and the like.

In some embodiments of the present disclosure, monitoring the execution state of the target processing task, that is, Step S1021 above, may be implemented as at least one of Steps S10211 to S10215.

Step S10211: obtaining communication connection information between the user terminal device and a processing device in the target device group, and determining the execution state of the target processing task based on the communication connection information.

Where, the processing device may be a first device in the target device group used to perform a device management function; it may also be a target processing device determined to collaboratively execute the target processing task.

In some embodiments of the present disclosure, the communication connection information between the user terminal device and the processing device in the target device group may include: information indicating establishment of a connection between the user terminal device and the processing device, operating information of communication modules in the user terminal device and the processing device, information indicating changes in a communication connection state, and the like.

Thus, when the communication connection information indicates that the user terminal device and the processing device are establishing a connection or have not successfully established a connection, the execution state of the target processing task is determined as not yet entering execution; when the communication connection information indicates that the user terminal device and the processing device have successfully established a point-to-point connection such as a peer-to-peer (P2P) connection or a mobile hotspot (Wi-Fi) connection, the execution state of the target processing task is determined as entering a preparation state for task execution; and the like.

Step S10212: obtaining transmission data between the user terminal device and a target processing device in the target device group, and determining the execution state of the target processing task based on the transmission data.

The target processing device refers to a processing device determined from the target device group to assist in processing the target processing task.

In some embodiments of the present disclosure, the target processing device may be determined based on an idle state of processing devices in the target device group; and the target processing device may also be determined based on a user selection at the user terminal device.

Transmission data may be any type of data transmitted between the user terminal device and the target processing device.

In some embodiments of the present disclosure, the transmission data may be task content data of the target processing task transmitted by the user terminal device to the target processing device, task processing result data transmitted by the target processing device to the user terminal device, or device connection data transmitted between the user terminal device and the target processing device, and the like.

Thus, based on the transmission data, the execution state of the target processing task may be determined.

For example, when the transmission data is task content data of the target processing task transmitted by the user terminal device to the target processing device, it indicates that the target processing task is in a task distribution state and has not yet started execution; for another example, when the transmission data is task processing result data transmitted by the target processing device to the user terminal device, it indicates that the target processing task is in an executing or executed state; for another example, when the transmission data is device connection data between the user terminal device and the target processing device, a task processing speed of the target processing task may be determined, and the user terminal device may also determine target processing device information of devices that collaboratively process the target processing task.

Step S10213: obtaining operating information of the user terminal device and/or a target processing device in the target device group, and determining the execution state of the target processing task based on the operating information.

Where, operating information refers to information related to a current device operating state of the user terminal device and/or the target processing device.

In some embodiments of the present disclosure, the operating information may include applications currently running on the user terminal device and/or the target processing device, AI models running, processors running (for example, a central processing unit (CPU), a graphics processing unit (GPU), a neural processing unit (NPU), and the like), operating power consumption, runtime duration, and the like.

In some embodiments of the present disclosure, the operating information further includes information indicating changes in a device operating state. For example, the device switches from a power-off state to a power-on state, from a power-on state to a power-off state, or from an online state to an offline state, and the like.

Thus, based on the above operating information, a processing speed and processing progress of the target processing task may be determined.

Step S10214: obtaining operation data applied by a target user to the interaction interface, and determining an execution state of the target processing task based on the operation data.

Where, the target user refers to a current user of the user terminal device or a legitimate user of the user terminal device.

The interaction interface refers to at least one of the initial interaction interface, the task interaction interface, and/or the device interaction interface.

Operation data refers to data corresponding to an input operation or a control operation performed by the target user in the interaction interface.

In some embodiments of the present disclosure, the operation data may be text information input by the target user in a text input box, voice information input by the target user through a voice input control, operation data by which the user adds a processing device in the target device group through a control for adding a processing device in the interaction interface, or data by which the user configures an execution state of the target processing task through the interaction interface, and the like.

Thus, based on the operation data, the execution state of the target processing task may be determined.

For example, when the operation data is text information input by the target user in the text input box or voice information input by the target user through the voice input control, it indicates that the target processing task is at a task initiation stage; for another example, when the operation data is operation data by which the user adds a processing device, it indicates that the target processing task is in a non-executing state; for another example, when the operation data is data by which the user configures the execution state of the target processing task through the interaction interface, it indicates that the target processing task is in a non-executing state, and a target processing device for processing the target processing task may be determined.

Step S10215: obtaining task information of the target processing task and device information of a device that executes the target processing task, and determining the execution state of the target processing task based on the task information and the device information.

Where, task information refers to information related to the target processing task.

In some embodiments of the present disclosure, task information includes task type information, for example, a text-to-image task, a text-to-text task, and the like.

In some embodiments of the present disclosure, task information further includes content information, for example, user input information corresponding to the text-to-image task or the text-to-text task.

In some embodiments of the present disclosure, task information further includes data volume information to be processed corresponding to the target processing task, and the like.

Where, a device that executes the target processing task may be the user terminal device or at least one processing device in a target device group. In some embodiments of the present disclosure, the target processing task may be collaboratively processed by the user terminal device and at least one processing device.

In some embodiments of the present disclosure, device information of a device that executes the target processing task may include hardware configuration information, software configuration information, idle state information, AI processing capability information, and the like.

Thus, based on the task information and the device information, the execution state of the target processing task may be determined. For example, based on the data volume information of the task to be processed in the task information together with the hardware configuration information, the idle state information, and the AI processing capability information in the device information, a completion speed of the target processing task may be determined, and a completion time of the target processing task may be estimated.

In the above embodiments, based on communication connection information between the user terminal device and at least one processing device, transmission data information, operating information, operation data of a target user, and/or the task information and the device information, the execution state of the target processing task is determined, and the task interaction interface is updated according to the execution state. In this way, the execution state of the target processing task is determined from a plurality of perspectives, and the task interaction interface corresponding to the task execution state is updated in real time, so that display effects of a display interface during task processing are more diverse and echo the task execution state, thereby better attracting user attention and enabling the user to intuitively perceive task processing, which improves user experience.

In some embodiments of the present disclosure, updating first display information of a display area in the first interaction area based on the execution state, that is, Step S1022 above, may be implemented as at least one of Steps S10221 to S10224.

Step S10221: when the execution state represents that the user terminal device has not obtained the target processing task, outputting first display content in the display area using first display parameters so as to present a first visual effect.

Where, outputting the first display content using the first display parameters means presenting the initial interaction interface in the first interaction area.

In some embodiments of the present disclosure, the first display content output using a first display parameter is optical paths and digital streams flowing downward, and the optical paths and the digital streams rebound upward after striking the text input box.

Under the first display parameter, the first display content provides a first visual effect resembling a splash after a water droplet falls, prompting the user that there is currently no input operation.

Step S10222: when an input operation applied to an input area in the first interaction area is monitored, outputting second display content in the display area using a second display parameter so as to present a second visual effect of transmitting data to the input area.

Where, the input area in the first interaction area refers to an area where a text input box, a voice input control, or a gesture input control in the first interaction area is located.

The input operation applied to the input area in the first interaction area refers to an input operation by which a target user inputs text through the text input box, inputs voice through the voice input control, or inputs gesture control information through the gesture input control, so as to enter a state or stage of initiating the target processing task through the input operation.

The second display content may be content the same as the first display content, for example, optical paths and digital streams flowing downward onto the text input box; and the second display content may also be content different from the first display content, for example, optical paths and digital streams flowing upward.

The second display parameters are display parameters different from the first display parameters.

For example, when the second display content is the same as the first display content, the second display content is output using a second display parameter different from the first display parameter, so that, when the user inputs information, the user may perceive different interactive effects of the display interface.

In some embodiments of the present disclosure, the second display content output using the second display parameter is, in response to a text input operation by the user, optical paths and digital streams flowing downward in the display area, and the optical paths and the digital streams present a second visual effect of being absorbed by the text input box.

In some embodiments of the present disclosure, in response to an increase in a text input speed in the text input box by the user, the second display parameter is updated so that the second display content is displayed at a faster speed, for example, by increasing a flow speed of the optical paths and the digital streams.

When the second display content is output using the second display parameter, the second visual effect of transmitting data to the input area is presented. Under the second visual effect, the user may intuitively see an interaction effect between the display area and the input area, thereby perceiving a processing progress of the user input information by the target processing device.

Step S10223: when the execution state represents that the user terminal device receives a processing result for the target processing task, outputting third display content in the display area using a third display parameter so as to present a third visual effect of interacting with the input area, the third display content including at least the processing result.

Where, the user terminal device receiving the processing result for the target processing task refers to a case where, during execution of the target processing task by the user terminal device or by at least one processing device in a target device group, a processing result for the target processing task is fed back to the user terminal device in real time for display in the display area of the user terminal device.

In some embodiments of the present disclosure, the third display content output using the third display parameter may include optical paths and digital streams flowing upward from the text input box; the third display content may further include displaying the processing result for the target processing task with a particle reconstruction effect.

Thus, by outputting the third display content using the third display parameter, the third visual effect of interacting with the input area is presented. Under the third visual effect, a user may intuitively perceive that a target processing device is executing the target processing task.

Step S10224: when the execution state represents that the user terminal device obtains a target processing result for the target processing task, outputting the target processing result in the display area using a fourth display parameter so as to present a fourth visual effect.

Where, obtaining the target processing result for the target processing task refers to obtaining a complete task processing result for the target processing task.

When outputting the target processing result using the fourth display parameter, when there are a plurality of processing results, the corresponding processing results may be displayed in respective cards, and a portion of the processing results may be enlarged for display according to a user operation.

In some embodiments of the present disclosure, when outputting the target processing result using the fourth display parameter, an entire area of the display area may be utilized to display the target processing result.

In some embodiments of the present disclosure, when outputting the target processing result using the fourth display parameter, content input by the user in the input box may be displayed as a floating window at a top of the display area or at another location; and the content input by the user in the input box may further be displayed in a semi-transparent form at a top of the display area or at another location.

In some embodiments of the present disclosure, the method further includes at least one of the following Steps S10225 to S10226.

Step S10225: obtaining an operation behavior parameter of an input operation applied to the input area in the first interaction area, and adjusting the second display parameter for outputting the second display content in the display area based on the operation behavior parameter.

Where, operation behavior refers to a behavior by which a target user inputs information in the input area. For example, the operation behavior includes a text input behavior, a voice input behavior, a gesture input behavior, an image input behavior, and the like.

In some embodiments of the present disclosure, the operation behavior parameter may include an input speed, an amount of input data, a volume level of voice input, and the like.

Thus, in response to a change in an operation behavior of a user input operation, the second display parameter of the second display content is dynamically adjusted, so that the second display parameter may reflect the change in the user’s operation behavior.

For example, when a text input speed increases while the user inputs text, a flow speed of optical paths and digital streams flowing downward is increased; for another example, when a volume level increases while the user inputs voice information, a flow speed of the optical paths and the digital streams flowing downward is increased.

Step S10226: in response to obtaining an editing operation applied to a target processing result in the display area of the first interaction area, performing an editing process corresponding on the target processing result.

Where, after the target processing result is displayed and output, a user may perform a further editing operation on the target processing result.

In some embodiments of the present disclosure, the editing operation may be a copy operation, a save-as operation, a beautification operation, a sharing operation, and the like, for the target processing result.

In some embodiments of the present disclosure, controlling the second interaction area of the initial interaction interface to output a device interaction interface corresponding to the execution state, that is, Step S103 above, may be implemented as at least one of the following Steps S1031 to S1032.

Step S1031: obtaining an avatar corresponding to device information of the user terminal device and processing devices in the target device group.

Where, when determining a device avatar to be displayed in the device interaction interface, it is required to refer to device information of the user terminal device and processing devices in the target device group.

In some embodiments of the present disclosure, device configuration information of the user terminal device and the processing device in the target device group may be obtained; based on a magnitude of device computing power in the device configuration information, a size and/or a type of the corresponding avatar is determined.

In some embodiments of the present disclosure, based on device information of the user terminal device and the processing device in the target device group, a preset device avatar may be obtained from a local database or a server.

In some embodiments of the present disclosure, based on device information of the user terminal device and the processing device in a target device group, a local processing model is used to generate respective avatars for the user terminal device and the processing devices in the target device group.

In some embodiments of the present disclosure, the avatar may be a planet avatar, a robot avatar, a plant avatar, a vehicle avatar, or any other type of avatar.

In some embodiments of the present disclosure, based on device information of the user terminal device and the processing device in the target device group, and user profile information of a target user, the local processing model generates an avatar type or avatar style that accords with user habits or preferences.

Step S1032: updating second display information of the avatar in the second interaction area based on the execution state so as to present a device interaction interface matching the execution state, where the second display information includes display content and/or a display parameter.

Where, based on the execution state of the target processing task, the second display information in the second interaction area is updated in real time, so that avatars of devices displayed in the second interaction area and animation effects between the avatars may match the execution state of the target processing task.

Display content corresponding to the second display information may include avatars of the user terminal device and at least one processing device, interaction content between avatars, background content of avatars, and the like.

Display parameters corresponding to the second display information may include a display size of an avatar, a display position, a rate of change, and the like.

In some embodiments of the present disclosure, Step S1032 above may be implemented as at least one of the following Steps S10321 to S10325.

Step S10321: obtaining target background content that matches the avatar, forming an interface of the second interaction area by respectively using the avatar and the target background content as a foreground layer and a background layer, and updating display parameters of the avatar and the target background content in the second interaction area based on the execution state so as to obtain a device interaction interface corresponding to the execution state.

Where, the target background content refers to background animation or background images corresponding to the avatar.

In some embodiments of the present disclosure, target background content is generated based on a type of the target processing task, user profile information of a target user, current environment information, a task objective corresponding to the target processing task, and the like.

For example, when the type of the target processing task is a text-to-image task, an image may be used as the target background content; target background content may further be selected as an image or animation of a type corresponding to a type of an image to be generated; and when the type of the target processing task is a text-to-text task, a calligraphy work may be used as the target background content.

For another example, when the user profile information of the target user indicates that the target user is female, images or animations of flowers may be used as the target background content; when the user profile information indicates that the target user is male, images or animations of vehicles may be used as the target background content.

For another example, when the current environment information indicates that the user terminal device is currently in an office environment, images or animations related to office scenes may be used as the target background content; and when the current environment information indicates that the user terminal device is currently in a home environment, images or animations in relaxed or entertainment styles may be used as the target background content.

Where, the avatar and the target background content are combined to obtain display content of the second interaction area.

In some embodiments of the present disclosure, an avatar of the user terminal device is combined with initial background content to obtain an initial interaction interface corresponding to the second interaction area.

In some embodiments of the present disclosure, in response to establishing a communication connection between the user terminal device and at least one processing device in the target device group, an avatar of the at least one corresponding processing device is displayed in the second interaction area.

In some embodiments of the present disclosure, in response to at least one processing device in the target device group switching from an offline state to an online state, an avatar of the at least one corresponding processing device is displayed in the second interaction area.

Step S10322: when the execution state represents that the user terminal device has not obtained the target processing task, outputting avatars of the user terminal device and at least one processing device in the target device group in the second interaction area using a fifth display parameter so as to present a fifth visual effect.

Where, when the target processing task has not been obtained, outputting avatars of the user terminal device and at least one processing device in the target device group using the fifth display parameter presents the fifth visual effect. Under the fifth visual effect, a user may intuitively see that there is currently no pending task.

In some embodiments of the present disclosure, under the fifth display parameter, the user terminal device and at least one processing device in the target device group have the same or similar display size and are displayed in a specified order.

In some embodiments of the present disclosure, under the fifth display parameter, different display colors are used among the user terminal device and at least one processing device in the target device group to distinguish available devices from unavailable devices. Where, an available device refers to a device that may assist the user terminal device in executing an AI task; and an unavailable device refers to a device that is in an offline state and is unable to assist the user terminal device in executing an AI task.

Step S10323: when an input operation applied to an input area in the first interaction area is monitored, outputting avatars of the user terminal device and a target processing device in the target device group in the second interaction area using a sixth display parameter so as to present a sixth visual effect of the user terminal device transmitting task data to the target processing device.

Where, the input operation applied to the input area in the first interaction area refers to an operation by which a user inputs text through a text input box or inputs voice information through a voice input control, and the like.

This input operation represents entering a state or stage of initiating the target processing task.

Thus, in response to the input operation, the user terminal device transmits task data of the target processing task to the target processing device. Therefore, avatars of the user terminal device and the target processing device in the target device group are output in the device interaction interface of the second interaction area using the sixth display parameter so as to present the sixth visual effect. Under the sixth visual effect, a user may intuitively see an action of the user terminal device transmitting task data to the target processing device.

In some embodiments of the present disclosure, under the sixth display parameter, a data transmission light effect is generated between the user terminal device and the target processing device, and the light effect echoes animation effects in the task interaction interface.

In some embodiments of the present disclosure, under the sixth display parameter, a display effect of an avatar of the target processing device is different from display effects of avatars of other processing devices. For example, outwardly diffusing light waves are formed around the avatar of the target processing device.

Thus, by adjusting display parameters of avatars of the user terminal device and the target processing device during a user input operation stage, interactive feedback for the user input operation is provided, thereby increasing amusement of user operations.

Step S10324: when the execution state represents that the user terminal device receives a processing result for the target processing task, outputting avatars of the user terminal device and the target processing device in the second interaction area using a seventh display parameter so as to present a seventh visual effect of the target processing device feeding back the processing result to the user terminal device.

Where, the user terminal device receiving the processing result for the target processing task refers to a case where, during execution of the target processing task by the target processing device, the processing result is fed back to the user terminal device in real time.

In response to the target processing device feeding back the processing result for the target processing task, display parameters of the avatars of the user terminal device and the target processing device are adjusted to present the seventh visual effect. Under the seventh visual effect, a user may intuitively see a state where the target processing device feeds back data to the user terminal device.

In some embodiments of the present disclosure, under the seventh display parameter, a data transmission light effect is generated between the target processing device and the user terminal device. For example, a light-beam effect directed from the target processing device toward the user terminal device is generated between the target processing device and the user terminal device.

Step S10325: when the execution state represents that the user terminal device obtains a target processing result for the target processing task, outputting avatars of the user terminal device and at least one processing device in the target device group in the second interaction area using the fifth display parameter so as to present the fifth visual effect.

Where, the user terminal device obtaining a target processing result for the target processing task refers to a case where the target processing device has completed execution of the target processing task and has completely transmitted the target processing result to the user terminal device.

In response to the target processing device feeding back the target processing result to the user terminal device, avatars of the user terminal device and at least one processing device in the target device group are output using the fifth display parameter so as to present the fifth visual effect. That is, after the target processing task is completed, avatars in the second interaction area are restored to an initial display effect to indicate to the user that there is currently no pending task.

In the above embodiments, based on different execution states of the target processing task, different display parameters are set for avatars and target background content in the second interaction area so as to provide different visual effects, enabling a user to determine a current execution stage of the target processing task based on display parameters of the avatars and the target background content. In this manner, user attention may be focused, and interactive interest may be improved.

In some embodiments of the present disclosure, the display control method further includes the following Steps S1226 to S1227.

Step S1226: when the execution state represents that the user terminal device receives a processing result for the target processing task, outputting hardware resource usage information of the target processing device in the first interaction area.

Where, the user terminal device receiving the processing result for the target processing task refers to real-time feedback of the processing result from the target processing device to the user terminal device during execution of the target processing task by the target processing device.

In response to receiving the processing result for the target processing task, hardware resource usage information of the target processing device is output in the first interaction area, so that the user may visually perceive an execution efficiency of the target processing device for the target processing task.

In some embodiments of the present disclosure, the hardware resource usage information includes usage data corresponding to respective hardware used by the target processing device to process the target processing task. For example, the hardware resource usage information includes an occupancy condition, an operating speed, and a release ratio of respective processors used to process the target processing task in the target processing device, and the like.

Step S1227: in response to obtaining a target interaction operation applied to the device interaction interface, adjusting display parameters of at least one avatar in the device interaction interface.

In some embodiments of the present disclosure, a target interaction operation refers to an operation by which a user, through the device interaction interface, adds a processing device interface, views device information, and the like.

Thus, when the target interaction operation is adding a processing device, an avatar corresponding to the processing device added by the user is added in the device interaction interface; when the target interaction operation is viewing device information, display parameters of an avatar corresponding to the device viewed by the user are updated so that the avatar of the device viewed by the user is distinguished from avatars of other devices.

In some embodiments of the present disclosure, the display control method provided by the present disclosure further includes the following Steps S104 to S106.

Step S104: after a first connection is established between the user terminal device and a first device, obtaining device information of each processing device in a target device group where the first device is located.

In some embodiments of the present disclosure, the first device may be a host device on a public network, and may also be a server in various local area networks.

Thus, when the first device is a host device on a public network, the user terminal device establishes the first connection with the first device, that is, the user terminal device logs into the public network host. For example, a user logs into the public network host through a personal computer (PC), a mobile phone, or a tablet computer.

The first device refers to a device in the target device group.

In some embodiments of the present disclosure, the first device may be a management device in the target device group, or may be any processing device in the target device group.

When the first device is the management device in the target device group, the target device group may be an intranet device group or cluster managed by the first device.

In some embodiments of the present disclosure, the first device may obtain device information, operating state information, and the like, of each processing device in the target device group so as to manage the processing devices.

Thus, when the user terminal device invokes at least one processing device in the target device group to assist in executing an AI processing task, the user terminal device first establishes the first connection with a target processing device so as to obtain, through the first device, device information of other devices in the target device group.

In some embodiments of the present disclosure, each processing device in the target device group may be an intranet device and may provide AI functions or AI services.

In some embodiments of the present disclosure, device information of each processing device in the target device group may include device identification information of each processing device, a device network address, device configuration information, device load state information, and the like.

Step S105: establishing a second connection between the user terminal device and a target processing device in the target device group based on the device information, and transmitting the target processing task to the target processing device through the second connection; where the first connection is different from the second connection, and the user terminal device and the processing device are in the same network or in different networks.

Where, based on the device information, the user terminal device determines the target processing device from processing devices of the target device group.

In some embodiments of the present disclosure, the device information includes computing power information, idle state information, and network state information of each processing device. Thus, based on the device information of each processing device, the user terminal device determines, as the target processing device, the processing device having the strongest computing power, the most idle state, and the best network state, so as to execute an AI task initiated by the user terminal device.

In some embodiments of the present disclosure, the user terminal device may establish the second connection with the target processing device based on device identification information or device network address information in the device information of the target device.

In some embodiments of the present disclosure, the second connection may be a peer-to-peer (P2P) direct network connection, a Wi-Fi connection, or another network communication connection.

In some embodiments of the present disclosure, the first connection and the second connection are communication connections that adopt different communication protocols, where the first connection is established based on a network connection protocol, and the second connection is established based on a data connection protocol.

In some embodiments of the present disclosure, the user terminal device and the target processing device are devices in the same network. For example, the user terminal device is a user’s mobile phone or tablet computer, and the target processing device may be the user’s PC in the same home network.

In some embodiments of the present disclosure, the user terminal device and the target processing device are devices in different networks. For example, the user terminal device is the user’s PC in a home network environment, and the target processing device is an AI device in an office network environment.

Where, the target processing task refers to an AI task. For example, the target processing task includes a text-to-image task, a text-to-text task, a video generation task, a task of creating a presentation (PPT), a summarization task, an image beautification task, and the like.

In some embodiments of the present disclosure, before the user terminal device transmits a target processing task to a target processing device, the target processing task is subjected to encryption processing so as to improve security of network transmission.

Step S106: outputting a target processing result for the target processing task, the target processing result being fed back by the target processing device in the target device group through the second connection.

In some embodiments of the present disclosure, outputting the target processing result corresponding to the target processing task may include displaying and outputting the target processing result on the user terminal device; and the outputting may further include synchronously outputting the target processing result to other terminal devices associated with the user terminal device. For example, when the user terminal device is a mobile phone, the target processing result may be displayed only on the mobile phone, or the target processing result may be synchronously displayed on the target user’s mobile phone, PC, and tablet computer.

In some embodiments of the present disclosure, before the target processing device feeds back the target processing result to the user terminal device, the target processing result is subjected to encryption processing. Therefore, before outputting the target processing result, decryption processing is performed on the target processing result.

Below, with reference to FIGS. 2 to 10, embodiments that utilize the display control method provided by the present disclosure are described by taking a tablet computer as the user terminal device.

The AI computing share application for executing the display control method provided by the present disclosure is downloaded and installed on the tablet computer.

After the AI computing share application is opened, a download application interface is entered, namely the interface 200 as shown in FIG. 2.

In the download application interface 200, text 210—“Download the compute-sharing application on other PC devices to enable inter-device invocation of AI capabilities”—prompts a user to download the AI computing share application on other devices so as to associate the tablet computer with other PC devices; and at the same time, a webpage link 220 for downloading the AI computing share application is provided.

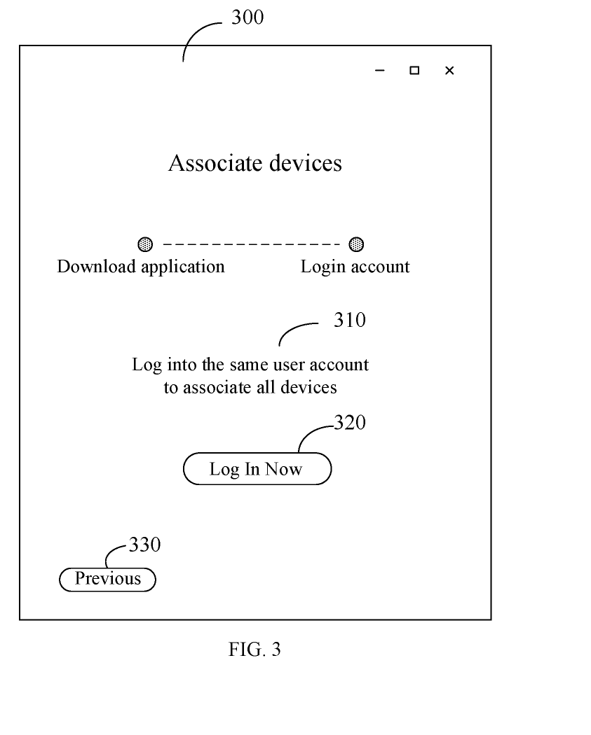

In response to a user clicking a “Next” button 230, a login account interface is entered, as shown in FIG. 3.

In the login account interface 300, text 310—“Log into the same user account to associate all devices”—prompts the user to log into a user account so as to associate all devices under the same account; a “Log In Now” control 320 is provided to offer a login entry; and at the same time, a “Previous” control 330 is provided so that the user may return to the download application interface 200 through the control 330.

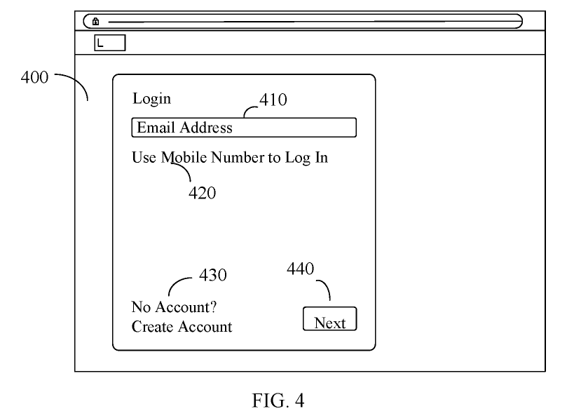

After a user clicks an “Log In Now” control 320, a login interface 400 is entered, as shown in FIG. 4.

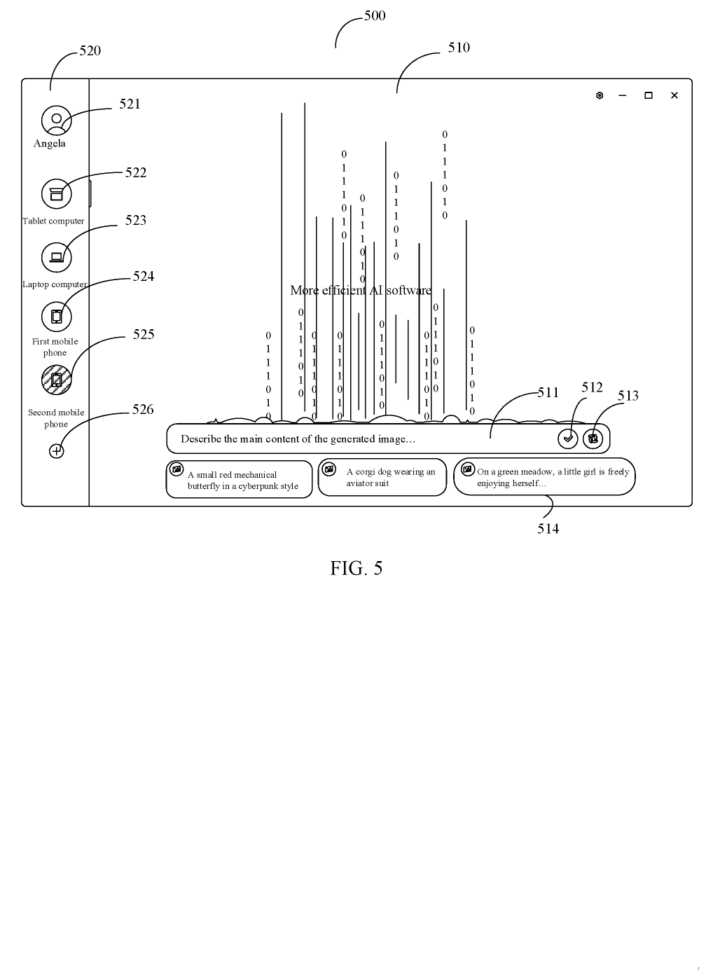

In the login interface 400, an “Email Address” input box 410 is provided so that a user may log in via an email address; by clicking a “Use Mobile Number to Log In” control 420, the user may switch to an interface for logging in with a mobile number; by clicking a “No Account? Create Account” control 430, the user may switch to a user registration interface; and by clicking a “Next” control 440, the user may enter an initial interaction interface 500 of the AI computing share application, as shown in FIG. 5.

As shown in FIG. 5, the initial interaction interface 500 of the AI computing share application includes a first interaction area 510 and a second interaction area 520.

The first interaction area 510 includes a text input box 511; a text sending control 512 and a voice input control 513 are arranged to the right of the text input box 511; an effect of optical paths and digital streams flowing downward is provided above the text input box 511, and the downward-flowing optical paths and digital streams rebound upward after striking the text input box 511 to form an effect of raindrops falling and splashing, indicating that there is currently no input content in the text input box 511; and, a plurality of historical search records 514 are provided below the text input box 511, and, by clicking a historical search record, historical interaction results may be presented.

The second interaction area 520 includes a user identifier 521; virtual identifiers of a plurality of devices, that is, a tablet computer identifier 522, a laptop computer identifier 523, a first mobile phone identifier 524, and a second mobile phone identifier 525, where the tablet identifier 522 is an identifier of a current device; a background of the second mobile phone identifier 525 is shaded, indicating that the second mobile phone is currently in an offline state; by clicking an add-device identifier 526, a user may associate more AI devices with the current device.

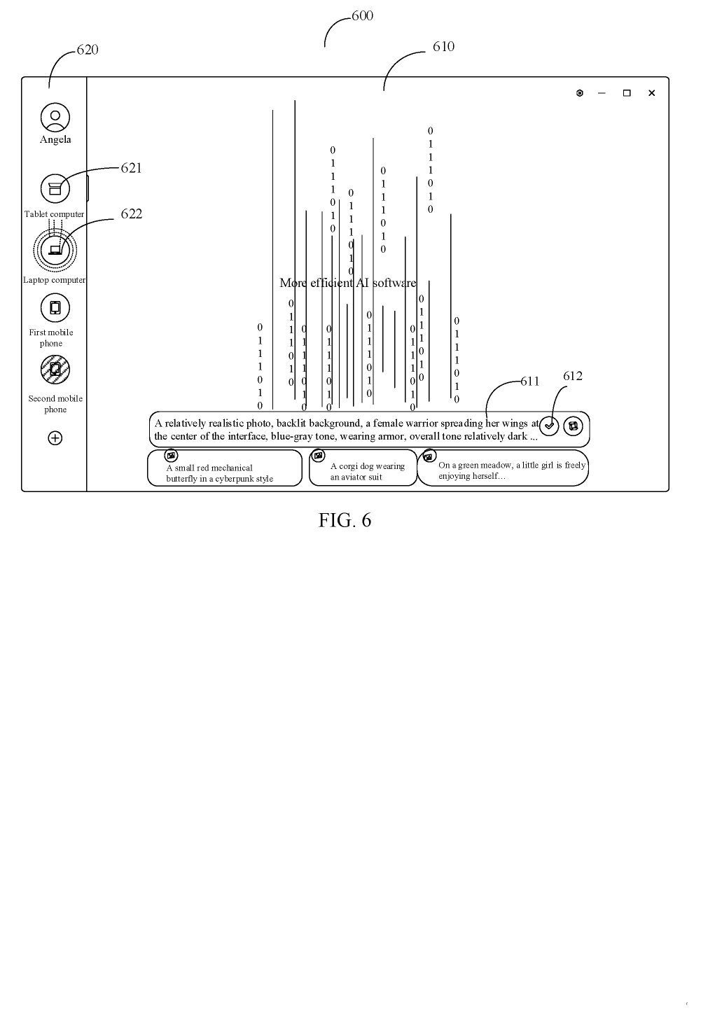

In response to the user inputting text information in the text input box 511, a task processing interface 600 is entered, as shown in FIG. 6.

In a task processing interface 600, a first interaction area 610 and a second interaction area 620 are included.

In response to a user inputting text information “A relatively realistic photo, backlit background, a female warrior spreading her wings at the center of the interface, blue-gray tone, wearing armor, overall tone relatively dark ...” into a text input box 611 in the first interaction area 610, a flow speed of optical paths and digital streams flowing downward above the text input box 611 increases and disappears into the text input box 611 so as to indicate that the AI computing share application is currently processing the user’s input information; meanwhile, the faster the user’s input speed, the faster the flow speed of the optical paths and the digital streams flowing downward above the text input box 611; and, in response to the user clicking a send control 612, the text information input by the user is sent, as a text-to-image task, to a laptop computer 623 for assisting in execution of the text-to-image task.

While the user inputs text information, a data-transmission light effect is presented between a tablet computer 621 and a laptop computer 622 in the second interaction area 620; and meanwhile, outwardly extending light waves are presented around the laptop computer 622 to indicate that the laptop computer 622 is in a data-processing state.

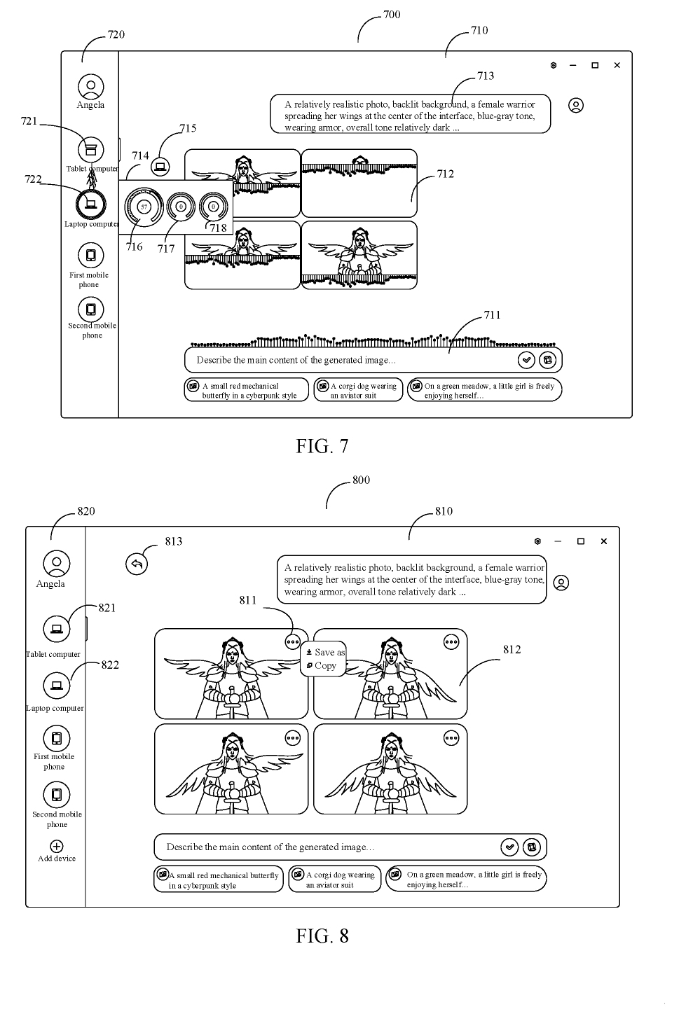

As shown in FIG. 7, in a task processing interface 700, a process is illustrated where, during execution of the text-to-image task by the laptop computer, a processing result for the text-to-image task is returned to the tablet computer.

In the first interaction area 710, an effect of optical paths flowing upward is displayed above the text input box 711 so as to indicate that an AI device is processing the text-to-image task.

Among four image generation results fed back by the laptop computer 722, a downward particle reconstruction effect is displayed below each image 712 so as to indicate that the image is being generated.

At a top of the first interaction area, current text information corresponding to the text-to-image task—“A relatively realistic photo, backlit background, a female warrior spreading her wings at the center of the interface, blue-gray tone, wearing armor, overall tone relatively dark ...”—is displayed in the form of a dialog box 713.

In a device information card 714, device information of a device that is processing a current task is displayed, where an avatar of a laptop computer 722 that is processing the current task is displayed above the device information card 714 in the form of a mini avatar 715; the device information card 714 displays operating states of three processors in the laptop computer 722, where operating information 716 is used to display a processor that provides the greatest computing power in the current processing task, for example, an NPU; and, operating information 717 and operating information 718 are used to display processors that do not provide computing power in the current processing task. In the operating information 716, different operating states are identified using arcs of different spans, where a shaded portion indicates computing power currently being used, and a numeral “57” indicates that the computing power currently being used accounts for 57% of a total computing power of the corresponding processor; the shaded portion together with a blank portion jointly identifies the total computing power of the current processor; and, a black line portion indicates computing power released during processing of the current task.

In a second interaction area 720, a light-beam effect directed from the laptop computer 722 toward the tablet computer 721 is presented between the tablet computer 721 and the laptop computer 722 so as to indicate that the laptop computer 722 is transmitting data to the tablet computer 721.

As shown in FIG. 8, a task processing interface 800 displays processing results for the current text-to-image task.

In a first interaction area 810, for a plurality of text-to-image results fed back by the laptop computer 822, that is, four images 812, a user may edit an image by clicking an edit control 811 on each image, for example, to perform a save-as operation or a copy operation; and, at the same time, a device information card corresponding to the laptop computer 822 is removed.

In a second interaction area 820, animation effects between the tablet computer 821 and the laptop computer 822 are removed so that display states of a plurality of devices displayed in the second interaction area 820 are restored to those before execution of the current processing task.

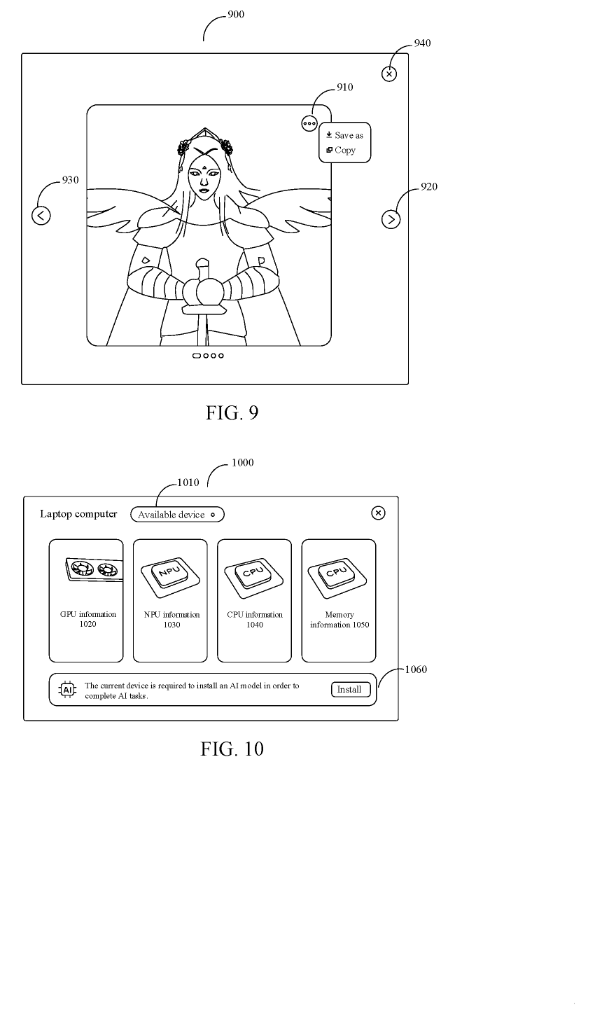

In response to a user’s zoom-in operation on the text-to-image results, four generated images 812 may be displayed in full screen, as shown in FIG. 9.

In an interaction interface 900 shown in FIG. 9, one image among the text-to-image results is displayed in full screen; and, edit controls 910, a next-image control 920, a previous-image control 930, and an exit-full-screen control 940 are included on the image.

Meanwhile, in response to a selection operation by a user on a device in the second interaction area (for example, the second interaction area 820 in FIG. 8), detailed device information may be displayed, as shown in FIG. 10.

In the interaction interface 1000 shown in FIG. 10, device information of the laptop computer is displayed. Where identification information 1010 indicates that the laptop computer is an available device, that is, may assist the tablet computer in executing an AI task; meanwhile, GPU information 1020, NPU information 1030, CPU information 1040, and memory information 1050 are displayed; and, when the laptop computer does not have an AI model installed, a prompt box 1060 may present “The current device is required to install an AI model in order to complete AI tasks.”

In view of the foregoing, in the display control method provided by the present disclosure: first, from entering a home page of the AI computing share application, to entering text for image generation, and then to image generation, the overall interface is smoothly connected by interactive animations, providing a more fluent and intuitive operating experience to a user; second, by visually combining animation effects during interaction with core software technologies, the user may intuitively understand core functionalities of the software through the interaction interface; and, third, during image generation by a device, usage data of a GPU, a CPU, and an NPU are acquired in real time, the acquired real-time data are processed to generate utilization, operating, and release ratio rates of respective processors, and the processed data are intuitively presented to the user in the form of interactive animations, enabling the user to dynamically observe working states and changes of respective processing units.

Based on the foregoing embodiments, the present disclosure provides a display control apparatus. The apparatus includes respective units and modules included in the respective units, and may be implemented by a processor in a computer device; the apparatus may also be implemented by specific logic circuits; and, during implementation, the processor may be a CPU, a microprocessor unit (MPU), a digital signal processor (DSP), or a field programmable gate array (FPGA), and the like.

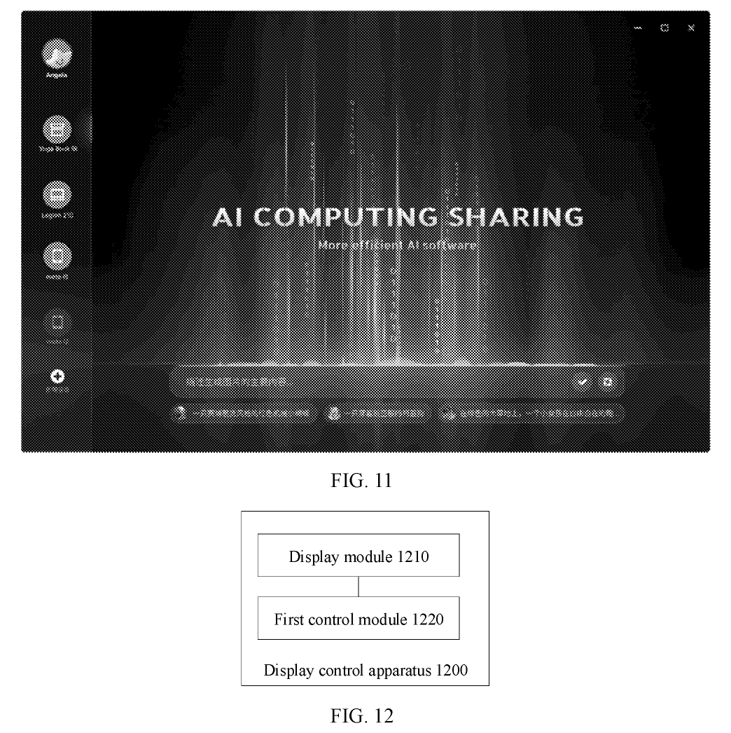

Additionally, as shown in FIG. 11, in a color interaction interface of the AI computing share application, when there is no text input in a text input box, optical paths and digital streams flow downward toward the text input box and rebound on the text input box to form a splash effect of raindrops. Thus, a user may intuitively see that there is currently no input information, and that the user terminal device and processing devices in the target device group are not providing computing power to process text information.

FIG. 12 illustrates a schematic structural diagram of a display control apparatus in accordance with some embodiments of the present disclosure. As shown in FIG. 12, a display control apparatus 1200 includes: a display module 1210 and a first control module 1220.

The display module 1210 is configured to display an initial interaction interface, the initial interaction interface including at least a first interaction area.

The first control module 1220 is configured to control the first interaction area to output a task interaction interface corresponding to an execution state of a target processing task so as to present different visual effects at different task stages.

Where the target processing task is obtained by a user terminal device based on an input operation applied to the first interaction area; and, before the target processing task is obtained, a visual effect presented by the first interaction area is different from a visual effect presented after the target processing task is obtained.

In some embodiments of the present disclosure, the apparatus 1200 further includes a second control module 1230. The second control module 1230 is configured to control a second interaction area of the initial interaction interface to output a device interaction interface corresponding to the execution state so as to present a processing procedure of the target processing task.

Where, the device interaction interface includes an avatar of the user terminal device and at least one processing device in a target device group, and the user terminal device belongs to or does not belong to the target device group; and, under different execution states, display parameters of the avatar in the corresponding device interaction interface are different.

In some embodiments of the present disclosure, the first control module 1220 is configured to:

in response to obtaining the target processing task, monitor an execution state of the target processing task; and

update first display information of a display area in the first interaction area based on the execution state so as to present different task interaction interfaces, where the first display information includes display content and/or a display parameter.

In some embodiments of the present disclosure, the first control module 1220 is configured to perform at least one of:

obtaining communication connection information between the user terminal device and a processing device in a target device group, and determining the execution state of the target processing task based on the communication connection information;

obtaining transmission data between the user terminal device and a target processing device in the target device group, and determining the execution state of the target processing task based on the transmission data;

obtaining operating information of the user terminal device and/or a target processing device in the target device group, and determining the execution state of the target processing task based on the operating information;

obtaining operation data applied by a target user to an interaction interface, and determining the execution state of the target processing task based on the operation data; or

obtaining task information of the target processing task and device information of a device that executes the target processing task, and determining the execution state of the target processing task based on the task information and the device information.

In some embodiments of the present disclosure, the first control module 1220 is configured to perform at least one of:

when the execution state represents that the user terminal device has not obtained the target processing task, outputting first display content in the display area using a first display parameter so as to present a first visual effect;

when an input operation applied to an input area in the first interaction area is monitored, outputting second display content in the display area using a second display parameter so as to present a second visual effect of transmitting data to the input area;

when the execution state represents that the user terminal device receives a processing result for the target processing task, outputting third display content in the display area using a third display parameter so as to present a third visual effect of interacting with the input area, the third display content including at least the processing result; or

when the execution state represents that the user terminal device obtains a target processing result for the target processing task, outputting the target processing result in the display area using fourth display parameters so as to present a fourth visual effect.

In some embodiments of the present disclosure, the first control module 1220 is further configured to perform at least one of:

obtaining an operation behavior parameter of an input operation applied to an input area in the first interaction area, and adjusting a second display parameter for outputting second display content in the display area based on the operation behavior parameter; and/or

in response to obtaining an editing operation applied to a target processing result in the display area of the first interaction area, performing a corresponding editing process on the target processing result.

In some embodiments of the present disclosure, the second control module 1230 is configured to:

obtain an avatar corresponding to device information of the user terminal device and processing devices in a target device group; and

update second display information of the avatar in the second interaction area based on an execution state so as to present a device interaction interface matching the execution state, where the second display information includes display content and/or a display parameter.

In some embodiments of the present disclosure, the second control module 1230 is configured to perform at least one of:

obtaining target background content matching the avatar, forming an interface of the second interaction area by respectively using the avatar and the target background content as a foreground layer and a background layer, and updating display parameters of the avatar and the target background content in the second interaction area based on the execution state so as to obtain a corresponding device interaction interface;

when the execution state represents that the user terminal device has not obtained the target processing task, outputting avatars of the user terminal device and at least one processing device in the target device group in the second interaction area using a fifth display parameter so as to present a fifth visual effect;

when an input operation applied to an input area in the first interaction area is monitored, outputting avatars of the user terminal device and a target processing device in the target device group in the second interaction area using a sixth display parameter so as to present a sixth visual effect of the user terminal device transmitting task data to the target processing device;

when the execution state represents that the user terminal device receives a processing result for the target processing task, avatars of the user terminal device and the target processing device are output in the second interaction area using a seventh display parameter so as to present a seventh visual effect of the target processing device feeding back the processing result to the user terminal device; or

when the execution state represents that the user terminal device obtains a target processing result for the target processing task, avatars of the user terminal device and at least one processing device in the target device group are output in the second interaction area using a fifth display parameter so as to present the fifth visual effect.

In some embodiments of the present disclosure, the second control module 1230 is configured to:

output hardware resource usage information of the target processing device in the first interaction area when the execution state represents that the user terminal device receives the processing result for the target processing task; and

in response to obtaining a target interaction operation applied to the device interaction interface, adjust a display parameter of at least one avatar in the device interaction interface.

In some embodiments of the present disclosure, the apparatus 1200 further includes:

a first communication module 1240, configured, after a first connection is established between the user terminal device and a first device, to obtain device information of each processing device in a target device group where the first device is located;

a second communication module 1250, configured to establish a second connection between the user terminal device and a target processing device in the target device group based on the device information, and to transmit the target processing task to the target processing device through the second connection; and

the display module 1210, configured to output a target processing result for the target processing task, the target processing result being fed back by the target processing device in the target device group through the second connection.

Where the first connection is different from the second connection, and the user terminal device and the processing device are in a same network or in different networks.

The foregoing description of the apparatus embodiments is similar to the foregoing description of the method embodiments and yields benefits similar to those of the method embodiments. In some embodiments of the present disclosure, functions of the apparatus or modules included in the apparatus are used to execute the methods described in the method embodiments above. Technical details not disclosed for the apparatus embodiments of the present disclosure are to be understood by reference to the description of the method embodiments of the present disclosure.

It should be noted that, in embodiments of the present disclosure, when the above display control method is implemented in the form of software function modules and sold or used as an independent product, the software function modules may also be stored in a computer- readable storage medium. Based on such understanding, technical solutions of the embodiments of the present disclosure may be embodied as a software product stored on a storage medium, the software product including a plurality of instructions for enabling a computer device (which may be a personal computer, a server, or a network device, and the like) to execute all or part of the methods described in the embodiments of the present disclosure. The foregoing storage medium includes various media on which program codes may be stored, such as a USB flash drive, a mobile hard disk, a read-only memory (ROM), a magnetic disk, or an optical disc. Thus, the embodiments of the present disclosure are not limited to any particular hardware, software, or firmware, or any combination of hardware, software, and firmware.

Embodiments of the present disclosure further provide a computer device including a memory and a processor. The memory stores a computer program operable on the processor, and, when the processor executes the program, the processor implements some or all of the steps of the methods described above.

In some embodiments of the present disclosure, a computer device is provided. The computer device includes a memory and a processor. The memory stores a computer program operable on the processor, and, when the processor executes the program, the processor implements some or all of the steps of the above method.

In some embodiments of the present disclosure, a computer-readable storage medium is provided. The computer-readable storage medium stores a computer program. When executed by a processor, the computer program implements some or all of the steps of the above methods. The computer-readable storage medium may be transitory or non-transitory.

In some embodiments of the present disclosure, a computer program is provided. The computer program includes computer-readable code. When run on a computer device, the computer-readable code causes a processor of the computer device to implement some or all of the steps of the above methods.

In some embodiments of the present disclosure, a computer program product is provided. The computer program product includes a non-transitory computer-readable storage medium storing a computer program. The computer program, when read and executed by a computer, implement some or all of the steps of the above methods. The computer program product may be implemented by hardware, by software, or by a combination thereof. In some embodiments, the computer program product is embodied as a computer storage medium; in other embodiments, the computer program product is embodied as a software product, such as a Software Development Kit (SDK), and the like.

It should be noted that the foregoing descriptions of the respective embodiments tend to emphasize differences among the embodiments, and identical or similar aspects may be cross-referenced. The foregoing descriptions of the apparatus, storage medium, computer program, and computer program product embodiments are similar to the descriptions of the method embodiments above and yield benefits similar to those of the method embodiments. Technical details not disclosed for the apparatus, storage medium, computer program, and computer program product embodiments of the present disclosure are to be understood with reference to the descriptions of the method embodiments of the present disclosure.

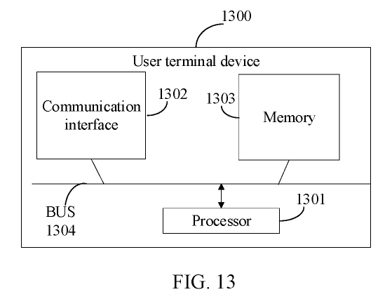

It should be noted that FIG. 13 illustrates a schematic hardware entity of a user terminal device according to some embodiments of the present disclosure. As shown in FIG. 13, a hardware entity of a user terminal device 1300 includes a processor 1301, a communication interface 1302, and a memory 1303.

The processor 1301 generally controls overall operations of the user terminal device 1300.

The communication interface 1302 allows the electronic device to communicate with another terminal or a server through a network.

The memory 1303 is configured to store instructions and applications executable by the processor 1301, and may further cache data to be processed by the processor 1301 and by respective modules of the user terminal device 1300, or data that has already been processed (for example, image data, audio data, voice communication data, and video communication data). The memory 1303 may be implemented by flash memory (FLASH) or random access memory (RAM). Data transmission among the processor 1301, the communication interface 1302, and the memory 1303 may be performed through a bus 1304.

It is to be understood that references throughout the specification to “one embodiment” or “an embodiment” mean that a particular feature, structure, or characteristic described in connection with the embodiment is included in at least one embodiment of the present disclosure. Therefore, the phrases “in one embodiment” or “in an embodiment” appearing in various places of the specification do not necessarily refer to the same embodiment. In addition, these particular features, structures, or characteristics may be combined in any suitable manner in one or more embodiments. It is to be understood that, in the various embodiments of the present disclosure, numerical designations assigned to the above steps/processes do not imply any order of execution; the order of execution of the steps/processes should be determined by their functions and inherent logic and should not impose any limitation on implementation of the embodiments of the present disclosure. The serial numbers of the embodiments are provided for descriptive convenience only and do not indicate any preference among embodiments.

It should be noted that, as used herein, the terms “include,” “including,” or any other variant thereof are intended to cover non-exclusive inclusion, such that a process, method, article, or apparatus that includes a list of elements is not limited to only those elements, but may also include other elements not expressly listed, or elements inherent to such process, method, article, or apparatus. Without further limitation, an element introduced by the phrase “including a …” does not preclude the presence of additional identical elements in the process, method, article, or apparatus that includes the element.

In the several embodiments provided by the present disclosure, it should be understood that the disclosed apparatuses and methods may be implemented in other ways. The apparatus embodiments described above are merely illustrative. For example, the division of units is only one logical functional division, and other divisions may be adopted in actual implementation; a plurality of units or components may be combined, may be integrated into another system, or certain features may be omitted or not performed. In addition, coupling, direct coupling, or communication connections among the respective components shown or discussed may be achieved through one or more interfaces, and indirect coupling or communication connections between devices or units may be electrical, mechanical, or in other forms.

Units described above as separate parts may or may not be physically separate, and components shown as units may or may not be physical units; they may be located in one place or distributed across a plurality of networked units; and some or all of the units may be selected as needed to achieve objectives of the embodiments of the present disclosure.

In addition, in embodiments of the present disclosure, the respective functional units may all be integrated into a single processing unit, may be implemented separately as respective units, or two or more units may be integrated into one unit. The integrated unit may be implemented in hardware, or may be implemented as a combination of hardware and software functional units.

Those of ordinary skill in the art will understand that all or part of the steps of the foregoing method embodiments may be completed by hardware related to program instructions. The foregoing program may be stored in a computer-readable storage medium and, when executed, performs the steps included in the foregoing method embodiments. The foregoing storage medium includes, by way of example, a mobile storage device, a read-only memory (ROM), a magnetic disk, or an optical disc, as well as other media capable of storing program code.

Alternatively, when the integrated units described above in the embodiments of the present disclosure are implemented in the form of software functional modules and are sold or used as an independent product, they may also be stored in a computer-readable storage medium. Based on this understanding, technical solutions of the present disclosure, in essence or at least portions that contribute to the related art, may be embodied as a software product stored on a storage medium, the computer software product including a plurality of instructions for enabling a computer device (which may be a personal computer, a server, or a network device, and the like) to execute all or part of the methods described in the embodiments of the present disclosure. The foregoing storage medium may include a mobile storage device, a read-only memory (ROM), a magnetic disk, an optical disc, and other media capable of storing program code.

The foregoing description sets forth embodiments of the present disclosure by way of example and is not intended to limit the scope of protection. Any modifications, variations, or substitutions that may be readily conceived by those skilled in the art within the scope of the technologies disclosed herein are intended to be encompassed within the scope of the present disclosure. Accordingly, the scope of the present disclosure is defined by the appended claims and equivalents thereof.

What is claimed is:

1. A display control method, comprising:
displaying an initial interaction interface, the initial interaction interface comprising at least a first interaction area; and
controlling the first interaction area to output a task interaction interface corresponding to an execution state of a target processing task, so as to present different visual effects at different task stages, wherein
the target processing task is obtained by a user terminal device based on an input operation applied to the first interaction area; and
before the target processing task is obtained, a visual effect presented by the first interaction area is different from a visual effect presented by the first interaction area after the target processing task is obtained.

2. The method according to claim 1, further comprising:
controlling a second interaction area of the initial interaction interface to output a device interaction interface corresponding to the execution state, so as to present a processing procedure of the target processing task, wherein
the device interaction interface comprises an avatar of the user terminal device and at least one processing device in a target device group, and the user terminal device belongs to or does not belong to the target device group; and
under different execution states of the target processing task, a display parameter of the avatar in the device interaction interface differs.

3. The method according to claim 2, wherein controlling the first interaction area to output the task interaction interface corresponding to the execution state of the target processing task comprises:
in response to obtaining the target processing task, monitoring the execution state of the target processing task; and
updating first display information of a display area in the first interaction area based on the execution state so as to present different task interaction interfaces, the first display information comprising display content and/or a display parameter.

4. The method according to claim 3, wherein monitoring the execution state of the target processing task comprises at least one of:
obtaining communication connection information between the user terminal device and a processing device in the target device group, and determining the execution state of the target processing task based on the communication connection information;
obtaining transmission data between the user terminal device and a target processing device in the target device group, and determining the execution state of the target processing task based on the transmission data;
obtaining operating information of the user terminal device and/or the target processing device in the target device group, and determining the execution state of the target processing task based on the operating information;
obtaining operation data applied by a target user to an interaction interface, or determining the execution state of the target processing task based on the operation data; or
obtaining task information of the target processing task and device information of a device that executes the target processing task, and determining the execution state of the target processing task based on the task information and the device information.

5. The method according to claim 3, wherein updating the first display information of the display area in the first interaction area based on the execution state comprises at least one of:
when the execution state represents that the user terminal device has not obtained the target processing task, outputting first display content in the display area using a first display parameter so as to present a first visual effect;
when an input operation applied to an input area in the first interaction area is monitored, outputting second display content in the display area using a second display parameter so as to present a second visual effect of transmitting data to the input area;
when the execution state represents that the user terminal device receives a processing result for the target processing task, outputting third display content in the display area using a third display parameter so as to present a third visual effect of interacting with the input area, the third display content comprising at least the processing result; or
when the execution state represents that the user terminal device obtains a target processing result for the target processing task, outputting the target processing result in the display area using a fourth display parameter so as to present a fourth visual effect.

6. The method according to claim 5, further comprising at least one of:
obtaining an operation behavior parameter of the input operation applied to the input area in the first interaction area, and adjusting the second display parameter for outputting the second display content in the display area based on the operation behavior parameter; or
in response to obtaining an editing operation applied to the target processing result in the display area of the first interaction area, performing a corresponding editing process on the target processing result.

7. The method according to claim 2, wherein controlling the second interaction area of the initial interaction interface to output the device interaction interface corresponding to the execution state comprises:
obtaining an avatar based on device information of the user terminal device and processing devices in the target device group; and
updating second display information of the avatar in the second interaction area based on the execution state so as to present the device interaction interface corresponding to the execution state, the second display information comprising display content and/or a display parameter.

8. The method according to claim 7, wherein updating the second display information of the avatar in the second interaction area based on the execution state comprises at least one of:
obtaining target background content matching the avatar, forming an interface of the second interaction area by respectively using the avatar and the target background content as a foreground layer and a background layer, and updating display parameters of the avatar and the target background content in the second interaction area based on the execution state so as to obtain the device interaction interface corresponding to the execution state;
when the execution state represents that the user terminal device has not obtained the target processing task, outputting an avatar of the user terminal device and at least one processing device in the target device group in the second interaction area using a fifth display parameter so as to present a fifth visual effect;
when an input operation applied to an input area in the first interaction area is monitored, outputting an avatar of the user terminal device and a target processing device in the target device group in the second interaction area using a sixth display parameter so as to present a sixth visual effect of the user terminal device transmitting task data to the target processing device;
when the execution state represents that the user terminal device receives a processing result for the target processing task, outputting an avatar of the user terminal device and the target processing device in the second interaction area using a seventh display parameter so as to present a seventh visual effect of the target processing device feeding back the processing result to the user terminal device; or
when the execution state represents that the user terminal device obtains a target processing result for the target processing task, outputting an avatar of the user terminal device and at least one processing device in the target device group in the second interaction area using the fifth display parameter so as to present the fifth visual effect.

9. The method according to claim 8, further comprising:
when the execution state represents that the user terminal device receives the processing result for the target processing task, outputting hardware resource usage information of the target processing device in the first interaction area; and
in response to obtaining a target interaction operation applied to the device interaction interface, adjusting a display parameter of at least one avatar in the device interaction interface.

10. The method according to claim 1, further comprising:
after a first connection is established between the user terminal device and a first device, obtaining device information of each processing device in a target device group where the first device is located;
establishing a second connection between the user terminal device and a target processing device in the target device group based on the device information, and transmitting the target processing task to the target processing device through the second connection; and
outputting a target processing result for the target processing task, the target processing result being fed back by the target processing device in the target device group through the second connection,
wherein the first connection is different from the second connection, and the user terminal device and the processing device are located in a same network or in different networks.

11. A user terminal device, comprising at least one processor and at least one processing model operable on the at least one processor, the processing model being invocable by a target application to execute at least one of following operations by the at least one processor:
displaying an initial interaction interface, the initial interaction interface comprising at least a first interaction area; and
controlling the first interaction area to output a task interaction interface corresponding to an execution state of a target processing task so as to present different visual effects at different stages of the target processing task, wherein
the target processing task is obtained by the user terminal device based on an input operation applied to the first interaction area; and
before the target processing task is obtained, a visual effect presented by the first interaction area is different from a visual effect presented after the target processing task is obtained.

12. The user terminal device according to claim 11, wherein the processing model is further invocable by the target application to control a second interaction area of the initial interaction interface to output a device interaction interface corresponding to the execution state so as to present a processing procedure of the target processing task, wherein
the device interaction interface comprises an avatar of the user terminal device and at least one processing device in a target device group; and
under different execution states of the target processing task, a display parameter of the avatar in the device interaction interface differs.

13. The user terminal device according to claim 11, wherein the at least one processor is further configured to perform:
in response to obtaining the target processing task, monitoring the execution state of the target processing task; and
updating first display information of a display area in the first interaction area based on the execution state so as to present different task interaction interfaces, the first display information comprising display content and/or a display parameter.

14. The user terminal device according to claim 13, wherein the at least one processor is further configured to perform at least one of:
obtaining communication connection information between the user terminal device and a processing device in a target device group, and determining the execution state based on the communication connection information;
obtaining transmission data between the user terminal device and a target processing device in the target device group, and determining the execution state based on the transmission data;
obtaining operating information of the user terminal device and/or the target processing device in the target device group, and determining the execution state based on the operating information;
obtaining operation data applied by a target user to an interaction interface, and determining the execution state based on the operation data; or
obtaining task information of the target processing task and device information of a device that executes the target processing task, and determining the execution state based on the task information and the device information.

15. The user terminal device according to claim 13, wherein the at least one processor is further configured to perform at least one of:
when the execution state represents that the user terminal device has not obtained the target processing task, outputting first display content in the display area using a first display parameter so as to present a first visual effect;
when an input operation applied to an input area in the first interaction area is monitored, outputting second display content in the display area using a second display parameter so as to present a second visual effect of transmitting data to the input area;
when the execution state represents that the user terminal device receives a processing result for the target processing task, outputting third display content in the display area using a third display parameter so as to present a third visual effect of interacting with the input area, the third display content comprising at least the processing result; or
when the execution state represents that the user terminal device obtains a target processing result for the target processing task, outputting the target processing result in the display area using a fourth display parameter so as to present a fourth visual effect.

16. The user terminal device according to claim 15, wherein the at least one processor is further configured to perform:
obtaining an operation behavior parameter of the input operation applied to the input area in the first interaction area, and adjusting the second display parameter for outputting the second display content in the display area based on the operation behavior parameter; and
in response to obtaining an editing operation applied to the target processing result in the display area of the first interaction area, performing a corresponding editing process on the target processing result.

17. The user terminal device according to claim 12, wherein the at least one processor is further configured to perform:
obtaining an avatar based on device information of the user terminal device and processing devices in the target device group; and
updating second display information of the avatar in the second interaction area based on the execution state so as to present the device interaction interface corresponding to the execution state, the second display information comprising display content and/or a display parameter.

18. The user terminal device according to claim 17, wherein the at least one processor is further configured to perform at least one of:
obtaining target background content matching the avatar, forming an interface of the second interaction area by respectively using the avatar and the target background content as a foreground layer and a background layer, and updating display parameters of the avatar and the target background content in the second interaction area based on the execution state so as to obtain the device interaction interface corresponding to the execution state;
when the execution state represents that the user terminal device has not obtained the target processing task, outputting an avatar of the user terminal device and at least one processing device in the target device group in the second interaction area using a fifth display parameter so as to present a fifth visual effect;
when an input operation applied to an input area in the first interaction area is monitored, outputting an avatar of the user terminal device and a target processing device in the target device group in the second interaction area using a sixth display parameter so as to present a sixth visual effect of the user terminal device transmitting task data to the target processing device;
when the execution state represents that the user terminal device receives a processing result for the target processing task, outputting an avatar of the user terminal device and the target processing device in the second interaction area using seventh display parameters so as to present a seventh visual effect of the target processing device feeding back the processing result to the user terminal device; or
when the execution state represents that the user terminal device obtains a target processing result for the target processing task, outputting an avatar of the user terminal device and at least one processing device in the target device group in the second interaction area using the fifth display parameter so as to present the fifth visual effect.

19. The user terminal device according to claim 18, wherein the at least one processor is further configured to perform:
when the execution state represents that the user terminal device receives the processing result for the target processing task, outputting hardware resource usage information of the target processing device in the first interaction area; and
in response to obtaining a target interaction operation applied to the device interaction interface, adjusting a display parameter of at least one avatar in the device interaction interface.

20. A non-transitory computer readable storage medium containing at least one processing model operable on at least one processor, the processing model being invocable by a target application to execute at least one of the following operations by the at least one processor:
displaying an initial interaction interface, the initial interaction interface comprising at least a first interaction area; and
controlling the first interaction area to output a task interaction interface corresponding to an execution state of a target processing task so as to present different visual effects at different stages of the target processing task, wherein
the target processing task is obtained by the user terminal device based on an input operation applied to the first interaction area; and
before the target processing task is obtained, a visual effect presented by the first interaction area is different from a visual effect presented after the target processing task is obtained.
